(19) United States
(12) Patent Application Publication
(10) Pub. No.: US 2026/0074299 A1
(43) Pub. Date: Mar. 12, 2026

(54) ELECTRODE PRECURSOR COMPOSITION

(71) Applicant: Dyson Technology Limited, Malmesbury, Wiltshire (GB)

(72) Inventors: Daniel Stephen MACPHERSON, Trowbridge (GB); Duncan Clifford Alan SMITH, Malmesbury (GB); Steven ROBSON, Bristol (GB); Alex MADSEN, Swindon (GB)

(21) Appl. No.: 19/104,497

(22) PCT Filed: Aug. 25, 2023
(86) PCT No.: PCT/IB2023/058433

§ 371 Date: Feb. 18, 2025

(30) Foreign Application Priority Data
Aug. 31, 2022 (GB) 2212606.4

(51) Int. Cl. H01M 10/42; C08J 3/11; C08J 5/18; C08K 3/04; C08K 3/22; H01M 4/62

(52) U.S. Cl. CPC H01M 10/4235; C08J 3/11; C08J 5/18; C08K 3/04; C08K 3/22; H01M 4/62; C08J 2327/16; C08J 2333/12; C08K 2003/2293; C08K 2201/001

(57) ABSTRACT

An electrode precursor composition for an alkali metal ion secondary cell is described. The composition includes a polymer-solvent gel matrix phase and a dispersed phase containing an electrochemically active material. The electrochemically active material has a multimodal particle size distribution having a D¹₅₀/D²₅₀ in the range 2 to 15. The electrode precursor composition can be processed into an electrode for an alkali metal ion secondary cell, for example a lithium ion secondary cell.

### FIELD OF THE INVENTION

The present invention relates to an electrode precursor composition for an alkali metal ion secondary cell. The invention also relates to electrodes, cells and energy storage devices made from such precursor compositions, along with methods of preparing electrodes for alkali metal ion secondary cells.

### BACKGROUND OF THE INVENTION

Lithium-ion secondary batteries are the leading battery technology currently used in applications from small personal devices to electric vehicles. Lithium-ion batteries are favoured for their high energy density and long cycle life, among other benefits. They contain a plurality of lithium-ion secondary cells, which is one example of an alkali metal ion secondary cell.

Traditional lithium-ion battery components such as electrodes are made from a solvent cast process that uses sacrificial solvent. This is an energetically expensive step, and a process that avoids using sacrificial solvent is therefore desirable.

A further major drawback of lithium-ion technology and other alkali-metal ion secondary cell technology is that a liquid electrolyte is often used within the lithium-ion cells of the battery, to provide conductivity of lithium ions within the cell between the solid, solvent cast anode and cathode. This causes safety problems since the liquid electrolytes are often highly flammable. This is a particular problem for electric vehicles, where a collision with another vehicle may be relatively likely and the resulting impact may cause damage to the battery and ignition of the electrolyte. It is also a problem for devices used in the home, where a lithium-ion battery fire could cause damage to property or serious injury.

One approach to avoiding the use of sacrificial solvent, and the need for liquid electrolyte within the cell, is preparing gel electrodes. These electrodes can be formed from a composition prepared by mixing the necessary components such as electrochemically active material, polymer, and a liquid electrolyte, and subsequently subjecting the composition to a thermal treatment.

Gel electrodes may be made from a precursor composition by thermal processing, for example hot rolling or extrusion. The energy density of the final electrode is determined at least in part by the loading of electrochemically active material within the gel electrode. As the loading of electrochemically active material within the precursor composition increases, all other things being equal the amount of force required to form an electrode film of given thickness rises exponentially. At a certain loading of electrochemically active material the forces involved in hot rolling of the precursor material make it impossible to form the final electrode product, for example due to damage to a carrier film, damage to the gel electrode itself (e.g. breakage or disintegration of the electrode) or by exceeding the limit of the roller assembly's ability to process the material into a film.

There is a need for gel electrode precursor compositions which are easier to process and can be processed into a high energy density electrode.

### SUMMARY OF THE INVENTION

The invention relates generally to an electrode precursor composition for an alkali metal ion secondary cell, and in particular to an electrode precursor composition comprising a multimodal dispersed phase comprising an electrochemically active material.

A first aspect of the invention is an electrode precursor composition for an alkali metal ion secondary cell comprising:
a polymer-solvent gel matrix phase; and
a dispersed phase comprising an electrochemically active material;
   wherein the electrochemically active material has a multimodal particle size distribution having a D¹₅₀/D²₅₀ in the range 2 to 15;
wherein D¹₅₀ is the volumetric median particle size of a first particle mode within the distribution and D²₅₀ is the volumetric median particle size of a second particle mode within the distribution.

The electrode precursor finds use as a precursor material for the preparation of a gel electrode.

The electrode precursor composition contains a polymer-solvent gel matrix phase and a dispersed phase of solid particulate material dispersed through the matrix phase. In this way, the electrode precursor composition has a gel-like composition and can be processed into a thin-film electrode with a similar gel-like composition, where the electrode structure contains a solvent component, for example liquid electrolyte trapped within the matrix phase due to the gelled nature of the polymer. Traditional solvent cast electrodes formed by solvent casting a slurry onto a substrate followed by drying require the separate addition of a free liquid electrolyte to the cell when assembled, creating a cell which is a fire risk due to the flammability of the free liquid electrolyte. The replacement of such solvent cast electrodes with a gel electrode prepared from the precursor composition of the invention reduces this risk and provides a cell of increased safety.

It has been found that the use of a dispersed phase comprising a multimodal particle size distribution having a D¹₅₀/D²₅₀ in the range 2 to 15 within a gel electrode precursor composition allows the active material loading of the electrode precursor composition to be increased to a level that is higher than would otherwise be possible if a monomodal particle size distribution was used. Without wishing to be bound by theory, it is believed that for such a particle size distribution having a D¹₅₀/D²₅₀ in the range 2 to 15, particularly efficient packing of the particles of the active material is achieved, which allows the material loading to be increased and the force exerted on the hot rollers during processing is lower than expected. As a result, it is possible to manufacture electrodes of a given thickness with higher active material loading and therefore higher energy density. Furthermore, due to the reduced load on the thermal processing equipment (e.g. hot rollers or extrusion die) the electrode production process requires lower energy and is therefore cheaper and more environmentally friendly.

The multimodal distribution additionally improves the flowability of the electrode Composite or gel composite before thermal processing, thereby easing processing.

The term “multimodal particle size distribution” indicates a particle size distribution containing two or more distinct peaks in the distribution having maxima at different particle sizes. One of the peaks may be a distinct shoulder of another peak, having a distinct maximum, or the peaks may be substantially non-overlapping, for example less than 30%, less than 25% or less than 20% of the area of one peak may be overlapping with another peak. The term “bimodal particle size distribution” indicates a particle size distribution containing exactly two distinct peaks in the distribution having maxima at different particle sizes. One of the peaks may be a distinct shoulder of another peak, having a distinct maximum, or the peaks may be substantially non-overlapping, for example less than 30%, less than 25% or less than 20% of the area of one peak may be overlapping with the second peak.

The term “particle mode” or “mode” refers to one peak within the bimodal or multimodal particle size distribution, representing a distribution of a single particle population within the overall distribution.

Preferred and/or optional features of the invention will now be set out. Any aspect of the invention may be combined with any other aspect of the invention unless the context demands otherwise. Any of the preferred and/or optional features of any aspect may be combined, either singly or in combination, with any aspect of the invention unless the context demands otherwise.

In some embodiments, the ratio of the volume fraction of the first particle mode (having a larger particle size) to the volume fraction of the second particle mode (having a smaller particle size) is from 0.6 to 15, for example from 0.6 to 12, for example from 0.6 to 10, for example from 1.0 to 10, for example from 1.2 to 9.5 or from 2 to 4.

In some embodiments, the ratio of the volume fraction of the first particle mode (having a larger particle size) to the volume fraction of the second particle mode (having a smaller particle size) is from 0.6 to 1.0, for example from 0.6 to 0.9, from 0.6 to 0.8, or from 0.7 to 0.8.

It has been found that such a ratio of volume fraction of the first particle mode to the volume fraction of the second particle mode provides particular improvements in active material loading and the ultimate energy density.

In some embodiments, the mass ratio of the first particle mode to the second particle mode is from about 60:40 to about 90:10, for example from about 65:35 to about 75:25.

In some embodiments, the electrochemically active material has a multimodal particle size distribution having a D¹₅₀/D²₅₀ in the range 2 to 10, for example 2 to 8, 2 to 7, 2 to 6, 2 to 5 or 2 to 4. In some embodiments, the electrochemically active material has a multimodal particle size distribution having a D¹₅₀/D²₅₀ in the range 2.5 to 3.5.

In some embodiments, the electrochemically active material has a multimodal particle size distribution having a D¹₅₀/D²₅₀ in the range 2 to 14, for example 4 to 14, 2 to 12, 4 to 12, 2 to 10, 4 to 10, 5 to 12, 5 to 10, 5 to 8, for example 6 to 8, or from 6.5 to 7.5 or about 7.

In some embodiments, the electrochemically active material has a multimodal particle size distribution having a D¹₅₀/D²₅₀ in the range 4 to 15, for example 7 to 15.

In some embodiments, the electrochemically active material has a multimodal particle size distribution having a D¹_{mode}/D²_{mode} in the range 2 to 15, wherein D¹_{mode} is the volumetric modal particle size of a first particle mode within the distribution and D²_{mode} is the volumetric modal particle size of a second particle mode within the distribution. In some embodiments, the electrochemically active material has a multimodal particle size distribution having a D¹₅₀₋/D²₅₀ in the range 2 to 10, for example 2 to 8, 2 to 7, 2 to 6, 2 to 5 or 2.5 to 4.5.

In some embodiments, the mass ratio of the first particle mode to the second particle mode is from about 65:35 to about 75:25 and the electrochemically active material has a multimodal particle size distribution having a D¹₅₀/D²₅₀ in the range 6 to 8.

In some embodiments, the electrochemically active material makes up at least 60 vol % of the electrode precursor composition, for example at least 61 vol %, at least 62 vol %, at least 63 vol %, at least 64 vol %, at least 65 vol %, at least 66 vol %, at least 67 vol % or at least 68 vol %.

Comparative electrode precursor compositions containing only a monomodal distribution of active material could not achieve high loading of active material and could not be processed into electrodes with loading higher than 60 vol %. By contrast, the electrode precursor compositions of the invention allow active material loading of at least 62 vol % and in some cases as high as 68 vol %.

In some embodiments the electrochemically active material makes up from 50 to 75 vol % of the electrode precursor composition, for example from 50 to 70 vol %, from 50 to 69 vol %, from 50 to 68 vol %, from 55 to 68 vol %, from 58 to 68 vol % or from 60 to 68 vol %.

In some embodiments the electrochemically active material makes up from 62 to 75 vol % of the electrode precursor composition, for example from 62 to 70 vol %, from 62 to 69 vol %, from 62 to 68 vol % or from 64 to 69 vol %.

The absolute values of the volumetric median particle size of a first particle mode within the distribution (D¹₅₀) and the volumetric median particle size of a second particle mode within the distribution (D²₅₀) are not particularly limited, provided that the above stated ratio is adhered to.

Nevertheless in some embodiments, the volumetric median particle size of the first particle mode within the distribution (D¹₅₀) is from 5 to 50 μm, for example from 5 to 40 μm, from 5 to 30 μm, from 5 to 25 μm, from 5 to 20 μm or from 10 to 20 μm.

In some embodiments, the volumetric median particle size of the second particle mode within the distribution (D²₅₀) is from 0.5 to 10 μm, for example from 0.5 to 8 μm, from 0.5 to 7 μm, from 1 to 7 μm, from 2 to 7 μm or from 3 to 7 μm.

The absolute values of the volumetric modal particle size of a first particle mode within the distribution (D¹_{mode}) and the volumetric modal particle size of a second particle mode within the distribution (D²_{mode}) are not particularly limited.

Nevertheless in some embodiments, the volumetric modal particle size of the first particle mode within the distribution (D¹_{mcde}) is from 5 to 50 μm, for example from 5 to 40 μm, from 5 to 30 μm, from 5 to 25 μm, from 5 to 20 μm, from 5 to 15 μm or from 9 to 15 μm.

In some embodiments, the volumetric median particle size of the second particle mode within the distribution (D²₅₀) is from 0.5 to 10 μm, for example from 0.5 to 8 μm, from 0.5 to 7 μm, from 1 to 7 μm, from 2 to 7 μm or from 2 to 5 μm.

D¹₅₀ and D²₅₀ are volumetric median particle sizes. In other words, they represent the particle size in microns which splits the volume distribution of that population of particles in half, with 50 vol % of the particles having a particle size below that value and 50 vol % having a particle size above that value. D¹₅₀ is therefore the particle size in microns which splits the volume distribution of the first particle mode in half, with 50 vol % of the particles having a particle size below the D¹₅₀ value and 50 vol % having a particle size above the D¹₅₀ value. D²₅₀ is the particle size in microns which splits the volume distribution of the second particle mode in half, with 50 vol % of the particles having a particle size below the D²₅₀ value and 50 vol % having a particle size above the D²₅₀ value.

D¹_{mode} and D²_{mode} are volumetric modal particle sizes. In other words, they represent the positions of the peaks in the particle size distribution, representing the particle sizes most commonly found in the distribution. So, D¹_{mode} is the particle size value at which the first particle mode of the distribution peaks, and D²_{mode} is the particle size value at which the second particle mode of the distribution peaks.

The skilled person will appreciate that the volume median particle sizes D¹₅₀ and D²₅₀ and volumetric modal particle sizes D¹_{mode} and D²_{mode} can be measured using a Malvern Mastersizer 3000 using the light scattering method set out in ASTM B822-20, applying the Mie scattering theory.

The skilled person will also understand that for particulate compositions containing a multimodal particle size distribution (e.g. bimodal), the PSD may be deconvoluted to calculate the volumetric median particle size of each particle mode using straightforward techniques well-known to the skilled person.

In some embodiments, the dispersed phase further comprises a conductive additive. This may be a particulate conductive additive.

In some embodiments, the conductive additive comprises or consists of a carbon additive. In some embodiments, the conductive additive comprises or consists of one or more of carbon black, and graphite. In some embodiments, the conductive additive comprises or consists of carbon black. Examples of commercially available carbon black include Ketjen Black and Super C65.

In some embodiments, the conductive additive is present in an amount of from 1.5 wt % to 2.5 wt %, based on the total weight of electrode precursor composition.

In some embodiments, the conductive additive is present in an amount of from 1.5 vol % to 2.5 vol %, based on the total weight of electrode precursor composition, for example from 1.5 vol % to 2.5 vol %, from 1.5 vol % to 2.4 vol %, from 1.5 vol % to 2.3 vol %, from 1.5 vol % to 2.2 vol %, from 1.5 vol % to 2.1 vol % or from 1.6 vol % to 2.1 vol %.

In some embodiments, the dispersed phase comprises from 2 vol % to 4 vol % of the conductive additive, based on the total volume of the dispersed phase, for example from 2.1 vol % to 3.9 vol %, from 2.2 vol % to 3.8 vol %, from 2.3 vol % to 3.7 vol %, from 2.3 vol % to 3.6 vol %, from 2.3 vol % to 3.5 vol % or from 2.4 vol % to 3.5 vol %.

In some embodiments, the dispersed phase comprises from 96 vol % to 98 vol % of the electrochemically active material, based on the total volume of the dispersed phase, for example from 96.1 vol % to 97.9 vol %, from 96.2 vol % to 97.8 vol %, from 96.3 vol % to 97.7 vol %, from 96.3 vol % to 97.6 vol %, from 96.3 vol % to 97.5 vol % or from 96.4 vol % to 97.5 vol %.

The dispersed phase may consist of the electrochemically active material and the conductive additive. In some embodiments the dispersed phase consists of the electrochemically active material and carbon black.

In some embodiments, the polymer-solvent gel matrix phase comprises a mixture of a gelling polymer and a solvent component, wherein the weight ratio of solvent component:polymer is from 2 to 6.

In some embodiments, the electrode precursor composition comprises the gelling polymer in an amount of from 5 to 10 vol %, based on the total volume of electrode precursor composition, for example from 5 to 9 vol %, from 5 to 8 vol %, from 5.5 to 8 vol % or from 6 to 8 vol %.

In some embodiments, the polymer-solvent gel matrix phase comprises the gelling polymer in an amount of from 15 to 25 vol %, based on the total volume of polymer-solvent gel matrix phase, for example from 15 to 24 vol %, from 16 to 24 vol %, from 17 to 24 vol %, from 17 to 23 vol %, from 18 to 23 vol %, from 18 to 22 vol %, from 19 to 22 vol %, from 19 to 21 vol %, or about 20 vol %.

In some embodiments, the polymer-solvent gel matrix phase comprises the solvent component in an amount of from 75 to 85 vol %, based on the total volume of polymer-solvent gel matrix phase, for example from 75 to 84 vol %, from 76 to 86 vol %, from 77 to 84 vol %, from 77 to 83 vol %, from 78 to 83 vol %, from 78 to 82 vol %, from 79 to 82 vol %, from 79 to 81 vol %, or about 80 vol %.

In some embodiments, the electrode precursor composition comprises the solvent component in an amount of from 20 to 35 vol %, based on the total volume of electrode precursor composition, for example from 21 to 34 vol %, from 22 to 33 vol %, from 23 to 32 vol % or from 24 to 31 vol %.

In some embodiments, the polymer-solvent gel matrix phase consists of the gelling polymer and the solvent component.

In some embodiments, the solvent component comprises or consists of a solvent comprising one or more cyclic or linear carbonate compounds. In some embodiments the solvent comprises one or more cyclic carbonate compounds. In some embodiments the solvent comprises one or more of ethylene carbonate, propylene carbonate, dimethyl carbonate, diethyl carbonate, ethyl-methyl carbonate, butylene carbonate, vinylene carbonate, fluoroethylene carbonate, fluoropropylene carbonate and γ-butyrolactone.

In some embodiments, the solvent component further comprises a lithium salt component. In some embodiments, the lithium salt component comprises one or more of lithium hexafluorophosphate (LiPF₆), lithium bis(trifluoromethanesulfonyl)imide (LiTFSI), lithium bis(fluorosulfonyl)imide (LiFSI), lithium difluoro (oxalato) borate (LiDFOB), lithium difluorophosphate, lithium bis(oxalato) borate, LiBF₄ and lithium 2-trifluoromethyl-4,5-dicyanoimidazole (LiTDI). In such cases where the solvent component comprises both solvent and a lithium salt component, the solvent component may also be described as an electrolyte component.

In some embodiments, the electrolyte component is a composition comprising:
(a) 5-35 wt % of lithium salt
(b) 2-10 wt % of additive; and
(c) 55-93 wt % solvent;
   wherein the lithium salt comprises:
(ai) a salt selected from lithium 2-trifluoromethyl-4,5-dicyanoimidazolide, lithium difluoro (oxalato) borate, lithium bis(oxalato) borate and lithium tetrafluroborate; and optionally
(aii) a co-salt selected from lithium bis(trifluoromethanesulfonyl)imide and/or lithium bis(fluorosulfonyl)imide;
wherein the molar ratio of the salt to co-salt is between 100:0 and 5:95;
   with the proviso that the composition does not comprise lithium bis(fluorosulfonyl)imide alongside lithium difluoro (oxalato) borate or lithium tetrafluoroborate;
   and wherein the additive comprises vinylene carbonate and optionally fluoroethylene carbonate;
and wherein the solvent comprises either (ci) ethylene carbonate and 10-30 mol % propylene carbonate, or (cii) γ-butyrolactone and optionally ethylene carbonate.

In some embodiments, the lithium concentration in the electrolyte component is between about 0.5 M and 2.0 M, for example between about 0.7M and 2.0M.

In some embodiments, the electrolyte component consists of (a) 5-35 wt % of lithium salt; (b) 2-10 wt % of additives; and (c) 55-93 wt % solvent.

In some embodiments, the additive in the electrolyte component consists of 30-90 mol % fluoroethylene carbonate and 10-70 mol % vinylene carbonate.

In some embodiments, the solvent in the electrolyte component consists of either (ci) 70-90 mol % ethylene carbonate and 10-30 mol % propylene carbonate, or (cii) 10-100 mol % γ-butyrolactone and optionally 0-90 mol % ethylene carbonate.

In some embodiments, the electrolyte component comprises 5-25 wt % of lithium salt, 2-10 wt % of additive and 65-93 wt % of solvent; wherein
(a) the lithium salt comprises 20-100 mol % lithium tetrafluroborate, and 0-95 mol % lithium bis(trifluoromethanesulfonyl)imide;
(b) the additive comprises 30-90 mol % fluoroethylene carbonate and 10-70 mol % vinylene carbonate; and
(c) the solvent comprises 70-90 mol % ethylene carbonate and 10-30 mol % propylene carbonate.

In some embodiments, the electrolyte component comprises 5-25 wt % of lithium salt, 2-10 wt % of additive and 65-93 wt % of solvent; wherein
(a) the lithium salt comprises 20-100 mol % of a mixture of lithium 2-trifluoromethyl-4,5-dicyanoimidazolide and lithium bis(oxalato) borate, and 0-95 mol % lithium bis(fluorosulfonyl)imide;
(b) the additive comprises 30-90 mol % fluoroethylene carbonate and 10-70 mol % vinylene carbonate; and
(c) the solvent comprises 70-90 mol % ethylene carbonate and 10-30 mol % propylene carbonate.

In some embodiments, the electrolyte component comprises 15-35 wt % of lithium salt, 2-10 wt % of additive and 55-83 wt % of solvent; wherein
(a) the lithium salt comprises 5-100 mol % of a mixture of lithium 2-trifluoromethyl-4,5-dicyanoimidazolide and lithium bis(oxalato) borate, and 0-95 mol % lithium bis(fluorosulfonyl)imide;
(b) the additive comprises 30-90 mol % fluoroethylene carbonate and 10-70 mol % vinylene carbonate; and
(c) the solvent comprises 0-90 mol % ethylene carbonate and 10-100 mol % γ-butyrolactone.

In some embodiments, the solvent component consists of one or more cyclic or linear carbonate compounds and a lithium salt.

In some embodiments, the polymer-solvent gel matrix phase makes up from 20 vol % to 50 vol % of the electrode precursor composition, for example from 25 vol % to 45 vol %, from 28 vol % to 42 vol %, from 30 vol % to 40 vol %, from 31 vol % to 49 vol % or from 32 vol % to 48 vol %.

The identity of the electrochemically active material in the invention is not of particular importance. The benefits of the invention based on the specific multimodal particle size distribution of the active material may be achieved for any active material which could be present in an electrode composition. The skilled person will be aware of a large number of possible electrochemically active materials, including cathode active materials (also called positive active materials) and anode active materials (also called negative active materials), which may be used in the present invention.

The electrochemically active material is a particulate material, i.e. a material made up of a plurality of discrete particles. The particles may comprise primary particles and/or secondary particles formed from the agglomeration of a plurality of primary particles.

In some embodiments, the electrochemically active material is a positive active material.

In some embodiments, the positive active material is a lithium transition metal oxide material. In some embodiments, the positive active material is a lithium transition metal oxide material comprising a mixed metal oxide of lithium and one or more transition metals, optionally further comprising one or more additional non-transition metals. In some embodiments, the positive active material is a lithium transition metal oxide material comprising lithium and one or more transition metals selected from nickel, cobalt and manganese. In some embodiments, the positive active material is selected from one or more of lithium cobalt oxide (LCO), lithium manganese oxide (LMO), lithium nickel cobalt oxide (NCO), aluminium-doped lithium nickel cobalt oxide (NCA), lithium nickel manganese cobalt oxide (NMC), lithium nickel oxide (LNO), lithium nickel manganese oxide (LNMO), lithium iron phosphate (LFP), lithium manganese iron phosphate (LFP) and lithium nickel vanadate (LNV). In some embodiments, the positive active material is lithium nickel manganese cobalt oxide (NMC), optionally doped with another metal such as aluminium.

In some cases, the electrochemically active material may comprise carbon, suitably graphite. graphene or a blend of carbon and a silicon oxide.

Such electrochemically active materials are commercially available or may be manufactured by methods known to the skilled person, for example through the precipitation of mixed metal hydroxide intermediates from a reaction mixture containing different precursor metal salts, followed by calcination to form a mixed metal oxide and optionally lithiation to incorporate lithium into the oxide.

The electrochemically active materials may be undoped or uncoated, or may contain one or more dopants and/or a coating. For example, the electrochemically active material may be doped with small amounts of one or more metal elements. The electrochemically active material may comprise a carbon coating on the surface of the particles of the material.

In some embodiments, the electrochemically active material is a negative active material.

In some embodiments, the electrochemically active material has a bimodal particle size distribution.

The polymer-solvent gel matrix phase comprises a gel matrix formed by the swelling of a swellable polymer when the polymer absorbs a solvent. The polymer-solvent gel matrix phase therefore comprises a gel comprising a polymer and absorbed solvent.

In some embodiments, the polymer-solvent gel matrix phase comprises one or more gelling polymers selected from poly(ethyleneglycol dimethacrylate), poly(ethyleneglycol diacrylate), poly(propyleneglycol dimethacrylate), poly(propyleneglycol diacrylate), poly(methyl methacrylate) (PMMA), poly(acrylonitrile) (PAN), polyurethane (PU), poly(vinylidene difluoride) (PVdF), poly(vinylidene fluoride-co-hexafluoropropylene) (PvDF-HFP), poly(ethylene oxide) (PEO), poly(ethyleneglycol dimethylether), poly(ethyleneglycol diethylether), poly[bis(methoxy ethoxyethoxide)-phosphazene], poly(dimethylsiloxane) (PDMS), polyacene, polydisulfide, polystyrene, polystyrene sulfonate, polypyrrole, polyaniline, polythiophene, polythione, polyvinyl pyridine (PVP), polyvinyl chloride (PVC), polyaniline, poly(3,4-ethylenedioxythiophene) (PEDOT), poly(p-phenylene). poly(triphenylene), polyazulene, polyfluorene, polynaphthalene, polyanthracene, polyfuran, polycarbazole, tetrathiafulvalene-substituted polystyrene, ferrocene-substituted polyethylene, carbazole-substituted polyethylene, polyoxyphenazine, poly(heteroacene), poly[(4-styrenesulfonyl) (trifluoromethanesulfonyl)imide-co-methoxy-polyethyleneglycolacrylate] (Li[PSTFSI-co-MPEGA]), sulfonated poly(phenylene oxide) (PPO), N,N-dimethylacryl amide (DMAAm), lithium 2-acrylamido-2-methyl-1-propane sulfonate (LiAMPS), Poly(lithium 2-Acrylamido-2-Methylpropanesulfonic Acid-Co-Vinyl Triethoxysilane), polyethyleneoxide (PEO)/poly(lithium sorbate), PEO/poly(lithium muconate), PEO/[poly(lithium sorbate)+BF₃], PEO copolymer, PEO terpolymer, and NIPPON SHOKUBAI® polymer.

In some embodiments, the polymer-solvent gel matrix phase comprises PMMA. In some embodiments, the polymer-solvent gel matrix phase comprises ultra-high molecular weight PMMA, for example with a molecular weight of greater than 100 kDa.

In some embodiments, the electrode precursor composition is for a lithium-ion secondary electrochemical cell. In some embodiments, the electrode precursor composition is a cathode precursor composition.

A second aspect of the invention is an electrode for an alkali metal ion secondary cell comprising:
a polymer-solvent gel matrix phase; and
a dispersed phase comprising an electrochemically active material;
   wherein the electrochemically active material has a multimodal particle size distribution having a D¹₅₀/D²₅₀ in the range 2 to 15;
wherein D¹₅₀ is the volumetric median particle size of a first particle mode within the distribution and D²₅₀ is the volumetric median particle size of a second particle mode within the distribution.

In some embodiments, the electrode is produced by processing an electrode precursor composition according to the first aspect to form a film.

Accordingly, the electrode may comprise a polymer-solvent gel matrix phase; and
a dispersed phase comprising an electrochemically active material;
   wherein the electrochemically active material has a multimodal particle size distribution having a D¹₅₀/D²₅₀ in the range 2 to 15;
wherein D¹₅₀ is the volumetric median particle size of a first particle mode within the distribution and D²₅₀ is the volumetric median particle size of a second particle mode within the distribution.

In some embodiments, the electrode is an extruded electrode. In other embodiments, the electrode is a hot-rolled electrode. In other embodiments, the electrode is prepared by extruding an electrode precursor composition according to the first aspect through a die to form a film.

In some embodiments, the electrode is a cathode.

All of the compositional options and preferences set out above for the electrode precursor composition of the first aspect relating to the identities of the various components of the composition (which do not change during the processing of the precursor composition) apply equally to the electrode of the second aspect.

With regards to the amounts of components in the electrode of the second aspect, the skilled person will understand that these may differ slightly from the amounts in the corresponding composition of the first aspect, due to the loss of some of the volatile components of the precursor composition during thermal processing to form the electrode. In general, it has been observed that around 10-20 vol % of the volatile fraction of the precursor composition is lost during processing. As a result, the weight or volume fraction of the remaining components as a proportion of the overall electrode composition will be slightly higher than in the precursor composition before processing. In general, there may be an increase of up to 4 vol % of a given component of the composition after thermal processing. So, for example, a component which initially makes up 10 vol % of the precursor composition may make up greater than 10 vol %, and up to 14 vol %, of the electrode composition after loss of volatiles during thermal processing. The skilled person will be able to easily calculate the expected proportions of each component in the final electrode composition based on the expected or measured volatile component loss.

In some embodiments, the processing comprises thermal processing or extrusion.

In some embodiments the thermal processing comprises passing the electrode precursor composition through a roller assembly at a temperature of at least 50° C., for example at least 60° C., at least 70° C., at least 80° C., at least 90° C. or at least 100° C. In some embodiments the thermal processing comprises passing the electrode precursor composition through rollers at a temperature of up to 150° C., for example up to 140° C. or up to 130° C. In some embodiments the thermal processing comprises passing the electrode precursor composition through rollers at a temperature of from 50° C. to 150° C., for example from 60° C. to 150° C., from 70° C. to 150° C., from 80° C. to 150° C., from 80° C. to 140° C., from 90° C. to 140° C. from 100° C. to 140° C. or from 110° C. to 130° C.

The roller assembly may comprise two rollers separated by a small distance such that the electrode is pressed into a thin film when passed through the rollers.

In some embodiments the thermal processing comprises extruding the electrode. In some embodiments the thermal processing comprises extruding the electrode using an extrusion apparatus comprising one or more screw feeding sections and an extrusion die. In some embodiments, the temperature of the die is at least 50° C., for example at least 60° C., at least 70° C., at least 80° C., at least 90° C. or at least 100° C. In some embodiments the temperature of the die is up to 150° C., for example up to 140° C. or up to 130° C. In some embodiments the temperature of the die is from 50° C. to 150° C., for example from 60° C. to 150° C., from 70° C. to 150° C., from 80° C. to 150° C., from 80° C. to 140° C., from 90° C. to 140° C., from 100° C. to 140° C. or from 110° C. to 130° C.

In some embodiments the electrode has a thickness of less than 150 μm, for example less than 100 μm, less than 90 μm, less than 80 μm or less than 70 μm. In some embodiments the electrode has a thickness of from 40 to 150 μm, for example from 40 to 100 μm, from 40 to 90 μm, from 40 to 80 μm, from 40 to 70 μm or from 50 to 70 μm.

In some embodiments the electrode has a thickness of from 40 to 150 μm, for example from 40 to 100 μm, from 40 to 90 μm, from 40 to 80 μm, from 40 to 70 μm or from 50 to 70 μm, and comprises the electrochemically active material in an amount of from 62 to 75 vol % of the electrode precursor composition, for example from 62 to 70 vol %, from 62 to 69 vol %, from 62 to 68 vol % or from 64 to 69 vol %.

In some embodiments the electrode has a porosity of less than about 5% by volume. In some cases, the porosity of the electrode is less than 5 vol %, less than 3 vol % or less than 2 vol %. To phrase in another manner, the volumetric density of the electrode may be at least 95%, suitably at least about 97% or 98% of the density of a perfectly non-porous electrode.

In some cases, the extruded electrode may for part of an extruded monolith which includes one or more further layers which are present in an electrochemical battery. For instance, the monolith may include a separator layer, and/or may include the other electrode (i.e. the extruded monolith may include both a cathode and anode). The different layers may be coextruded and have different compositions from one another.

A third aspect of the invention provides an electrochemical secondary cell comprising an electrode according to the second aspect. The cell may be an alkali metal ion secondary cell, for example a sodium-ion secondary cell or a lithium-ion secondary cell. Preferably the cell is a lithium-ion secondary cell. In some embodiments the electrochemical secondary cell comprises a first electrode according to the second aspect, wherein the first electrode is a cathode, and a second electrode according to the second aspect, wherein the second electrode is an anode, and an electrolyte between the cathode and the anode. In some embodiments the electrochemical secondary cell comprises an electrode according to the second aspect laminated with a current collector, for example a metallic foil.

A fourth aspect of the invention provides an electrochemical energy storage device comprising an electrochemical secondary cell according to the third aspect. In some embodiments, the electrochemical energy storage device is a battery. In some embodiments, the electrochemical energy storage device is a lithium-ion battery.

A fifth aspect of the invention provides a method of preparing an electrode for an alkali metal ion secondary cell, comprising:
mixing a polymer, a solvent component and an electrochemically active material to form an electrode precursor composition according to the first aspect; and
thermally processing the electrode precursor composition to form an electrode film.

In some embodiments, the electrode film has a thickness of from 500 to 700 μm.

In some embodiments, the method further comprises cutting the electrode film to form an electrode of predetermined dimensions.

In some embodiments, the method further comprises performing a second thermal processing step on the cut film to reduce the thickness of the film to within a range of 50 to 70 μm.

In some embodiments, the temperature during thermal processing is from 100 to 140° C.

### BRIEF DESCRIPTION OF THE DRAWINGS

FIG. 1 schematically illustrates the increase in particle loading possible through optimising the particle size distribution as a function of viscosity.

FIG. 2 shows a rate graph, measured at 30° C. for a cell including an electrode according to the invention.

FIG. 3 schematically illustrates an electrode according to the present invention.

FIG. 4 shows the particle size distribution of a first grade of NMC cathode active material used in the Examples.

FIG. 5 shows the particle size distribution of a second grade of NMC cathode active material used in the Examples.

FIG. 6 shows the particle size distribution of a third grade of NMC cathode active material used in the Examples.

FIG. 7 shows the particle size distribution of a fourth grade of NMC cathode active material used in the Examples.

FIG. 8 shows the particle size distribution of a fifth grade of NMC cathode active material used in the Examples.

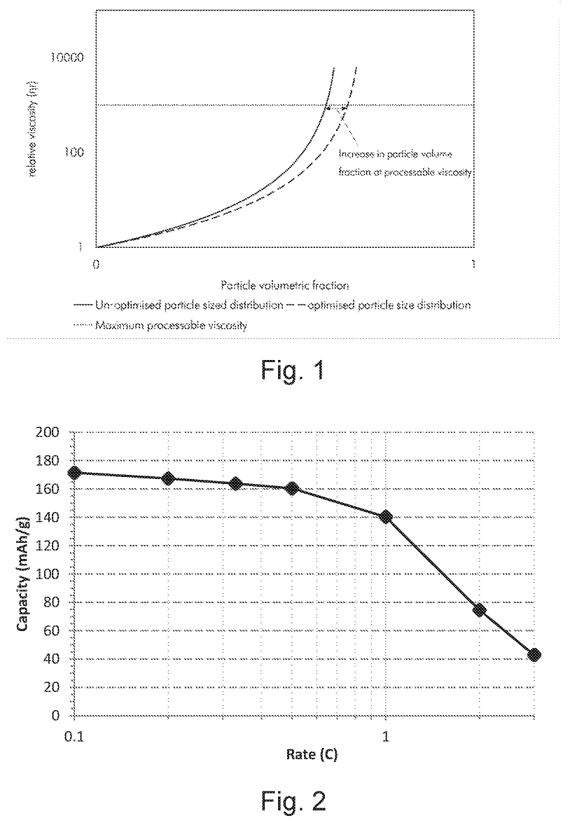

### EXAMPLES

For all samples tested the active material, conductive carbon, polymer, and electrolyte were first weighed and mixed by hand until the mixture was even and lump free. This mixture was then fed into a twin-screw extruder with three mixing zones at several intervals. The main body of the twin screw extruder was held at 120 degrees over the mixing zones, with a ramp from 40 degrees from the input port and a drop off to 80 degrees at the exit. After this material was fed into the twin-screw extruder it was collected in the form of a granular mixture.

This granular mixture was then rolled into a thin film. Precursor material was sandwiched between two sheets of mylar and fed through a rolling mill at 120° C., with the roller gap set to ensure the material was pressed to a thickness of 600 μm.

This 600 μm thick precursor film was then cut to 500 mm×10 mm to assess the ability to form a thin film. This section of film was then fed into the same hot roller assembly with rollers set to a smaller distance, to create a film of target thickness, typically 50-70 μm depending on formulation.

Formulations that failed to form thin films were observed to fail at different steps of the process, but typically they failed at the formation of the 600 μm thick precursor film. This failure typically manifested as the formation of a non-uniform film, often considerably thicker than intended, often destroying carrier films in the process. On some occasions the heated rollers of the assembly were prevented from turning and film formation was not possible.

### Active Materials

Five grades of lithium nickel manganese cobalt oxide (NMC) were used in the tests, each having a different particle size distribution.

“NMC grade #1” is lithium-nickel-manganese-cobalt-oxide having a bimodal particle size distribution shown in FIG. 4. The ratio of the volume fraction of the larger particle mode to the volume fraction of the smaller particle mode is 9.31. The parameter D¹₅₀/D²₅₀ for the material is 3.30.

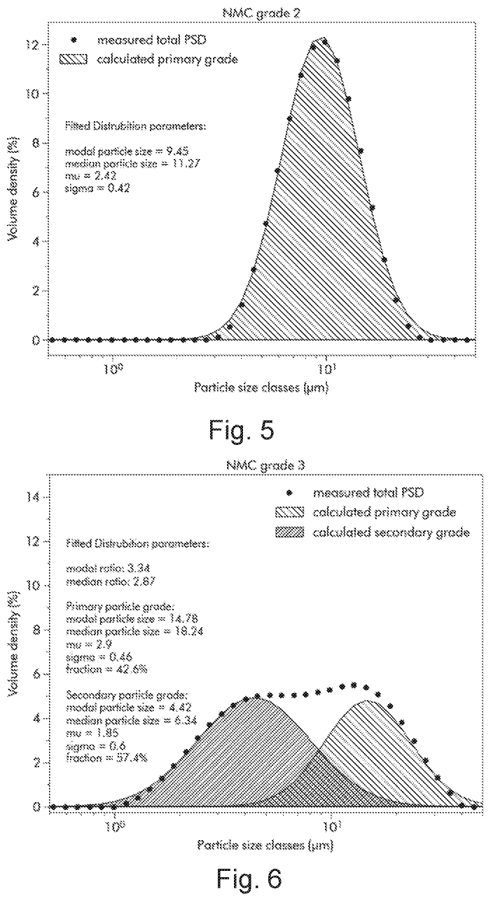

“NMC grade #2” is lithium-nickel-manganese-cobalt-oxide having a monomodal particle size distribution shown in FIG. 5. The median particle size is 11.27 μm.

“NMC grade #3” is lithium-nickel-manganese-cobalt-oxide having a bimodal particle size distribution shown in FIG. 6. The ratio of the volume fraction of the larger particle mode to the volume fraction of the smaller particle mode is 0.74. The parameter D¹₅₀/D²₅₀ for the material is 2.87.

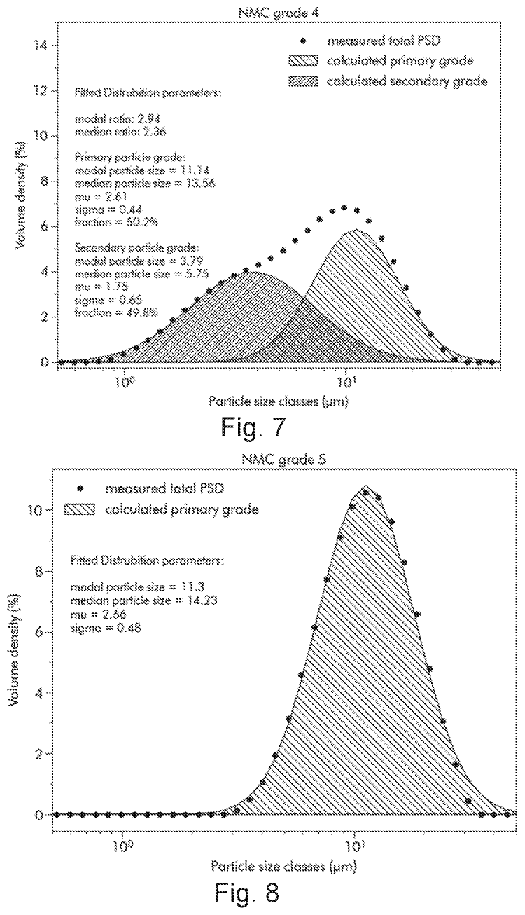

“NMC grade #4” is lithium-nickel-manganese-cobalt-oxide having a bimodal particle size distribution shown in FIG. 7. The ratio of the volume fraction of the larger particle mode to the volume fraction of the smaller particle mode is 1.01. The parameter D¹₅₀/D²₅₀ for the material is 2.36.

“NMC grade #5” is lithium-nickel-manganese-cobalt-oxide having a monomodal particle size distribution shown in FIG. 8. The median particle size is 14.23 μm.

Particle size distributions were measured for each of the NMC grades using a Malvern Mastersizer 3000 using the light scattering method set out in ASTM B822-20, applying the Mie scattering theory. The individual particle modes within each grade were then resolved by peak fitting.

### Example 1

The electrode precursor compositions shown in Table 1 were prepared and tested according to the method set out above.

Each composition contained ultra-high molecular weight (>100 kDa) poly(methyl methacrylate) (PMMA) as the polymer.

The carbon additive was carbon black.

The electrolyte was a mixture of a carbonate solvent, a lithium salt and an additive as described earlier in the specification.

TABLE 1

| | | Active | Polymer | | |
|---|---|---|---|---|---|
| | Active | material | (PMMA) | Carbon | Electrolyte |
| Composition | material | vol % | vol % | vol % | vol % |
| 1 | NMC Grade | 60 | 7.58 | 2.10 | 30.32 |
| | #1 | | | | |
| 2 | NMC Grade | 62 | 7.20 | 2.00 | 28.80 |
| | #1 | | | | |
| 3 | NMC Grade | 64 | 6.82 | 1.89 | 27.29 |
| | #1 | | | | |
| 4 | NMC Grade | 66 | 6.44 | 1.79 | 25.77 |
| | #1 | | | | |
| 5 | NMC Grade | 68 | 6.06 | 1.68 | 24.26 |
| | #1 | | | | |
| 6 | NMC Grade | 68 | 6.06 | 1.68 | 24.26 |
| | #1 | | | | |
| 7 | NMC Grade | 64 | 6.82 | 1.89 | 27.29 |
| | #3 | | | | |
| 8 | NMC Grade | 68 | 6.06 | 1.68 | 24.26 |
| | #3 | | | | |
| 9 | NMC Grade | 68 | 6.06 | 1.68 | 24.26 |
| | #3 | | | | |
| A | NMC Grade | 60 | 7.58 | 2.10 | 30.32 |
| | #2 | | | | |
| B | NMC Grade | 64 | 6.82 | 1.89 | 27.29 |
| | #2 | | | | |

The results for each composition during the film forming process are set out in Table 2 below. “Pass” indicates that the composition was successfully formed into a thin film by the hot roller method set out above. “Fail” indicates that formation of a thin film was not possible for the precursor composition tested.

TABLE 2

| Composition | Pass/Fail |
|---|---|
| 1 | Pass |
| 2 | Pass |
| 3 | Pass |
| 4 | Fail |
| 5 | Fail |
| 6 | Fail |
| 7 | Pass |
| 8 | Pass |
| 9 | Pass |
| A | Pass |
| B | Fail |

The results in Table 2 show that the compositions containing a bimodal electrochemically active material could be successfully processed into a thin film at higher material loadings. A material loading of 64 vol % was achievable with NMC Grade #1 (Compositions 1-3) with failure only being observed when material loading was pushed to 66 vol % or higher (Compositions 4-6). An even greater material loading of 68 vol % was achievable with NMC Grade #3 (Compositions 7-9), with no failure observed for any of the compositions tested containing that material.

The comparative compositions A and B, containing the monomodal electrochemically active material NMC Grade #2, could be processed into a thin film at a relatively low material loading of 60 vol %, but failed at a loading of 64 vol %.

It is clear from these results that the presence of a bimodal electrochemically active material allows the active material loading to be higher without causing failure of the electrode forming process. The compositions containing the material NMC Grade #3 performed particularly well, with loadings of 68 vol % being possible.

### Example 2

The following composition (Composition 10) was prepared:

| | | % volume, adjusted |
|---|---|---|
| | % | for solvent loss |
| Component | weight | in extrusion process |
| Cathode active material | 84.4 | 65.51 |
| (NMC Grade #5) | | |
| PVDF21510 (PVDF-HFP) | 4.867 | 10.12 |
| Ethylene Carbonate | 9.733 | 22.42 |
| Ketjen Black E600 | 0.5 | 0.97 |
| Super C65 | 0.5 | 0.97 |

The formulation components were mixed together in a single pot prior to feeding into an extruder. Alternatively, each individual component could be fed into the extruder separately, via individually controlled feed systems.

The powder mix was then fed into the extruder at a specific and controlled rate. In this case, a feed rate of 400-500 g/h was used.

The first element of the extruder, a twin screw compounding section, was used to melt and mix the composition. This had a temperature set to 110° C. to sufficiently melt the gel components, and a RPM set sufficiently high to ensure <80% torque (in this case it was set to 100 RPM). The twin screw design included three mixing zones providing the required high shear to fully mix the material.

The second element of the extruder, a single screw, was set to provide constant flow/pressure, and compression of the material. The speed of the screw was set sufficiently low to minimise pressure variation and sufficiently high to avoid material back-up in the twin screw. In this case it was set to 25 RPM. The temperature was set sufficiently high to keep the material in the melt phase, in this case 110° C.

The third section of the extruder is the film die. The purpose of the film die is to take material extruded by the single screw as a tubular shape and widen and flatten it into a film of desired dimensions. In this case the die used had final dimensions of 50 mm×0.6 mm. The temperature of the die was set to 120° C.

### Example 3

The following composition (Composition 11) was prepared:

| | | % volume, |
|---|---|---|
| | | adjusted for |
| | % | solvent loss in |
| Component | weight | extrusion process |
| Cathode active material | 84.4 | 65.51 |
| (NMC Grade #4) | | |
| PVDF21510 (PVDF-HFP) | 4.867 | 10.12 |
| Ethylene Carbonate | 9.733 | 22.42 |
| Ketjen Black E600 | 0.5 | 0.97 |
| Super C65 | 0.5 | 0.97 |

The extrusion method used in Example 3 was identical with that of Example 2.

By repeating the experiment in Example 2 using 84.4 wt % of bimodal cathode material (NMC Grade #4) it was observed that while extrusion was still not completely defect free, the pressure at the die entrance (indicative of viscosity/ease of extrusion) was lower, and the film quality was improved.

### Example 4

Extruded electrodes from Example 3 were characterised by several key metrics. Primarily density measurements were taken via manual weight/volume measurements, and secondarily via helium pycnometry. These were compared to theoretical density measurements as calculated from the formulation.

Using TGA it was observed that in the final electrode film, the solvent (ethylene carbonate) content was lower than the initial formulation. This was determined by weighing the mass loss when the sample was taken to 200° C. This established that a small fraction of the solvent was evaporating during the extrusion process, about 1.7% of the total formulation weight, bringing the total solvent content down from 9.7% to ˜8%. The corresponding formulation density calculation uses this value.

| | | Formulation | | |
|---|---|---|---|---|
| | Formulation | Density - TGA | Density - | Density - |
| | Density | corrected | Manual | Pycnometry |
| Sample | (g · cm⁻³) | (g · cm⁻³) | (g · cm⁻³) | (g · cm⁻³) |
| Sample 1 | 3.48 | 3.62 | 3.62-3.65 | 3.644 ± |
| | | | | 0.008 |
| Sample 2 | 3.48 | 3.62 | 3.55 | 3.622 ± |
| | | | | 0.005 |

The conclusion of this density characterisation is that the material has no (or a negligibly small) porosity. A formulation density considerably higher than measured density would be indicative of porosity. A small amount of solvent is lost in the manufacturing process, and this lost fraction does not appear to introduce porosity.

### Example 5

In this Example, electrode material as made in the above Examples 2-4 was tested within a cell. To test the electrochemical performance of this electrode the material was laminated onto aluminium foil. To achieve this the foil was first primed with a primer solution of 3% PVDF5130 in NMP. This was applied via soaked cotton bud to achieve a very thin layer. When attempts were made to measure the thickness of this layer it could not be detected either by micrometer measurement or weighing samples of the primed foil. This indicates that the thickness of the layer is sub-micron.

The purpose of this primer layer is to achieve adhesion between the electrode and the current collector foil.

This current collector-electrode laminate was soaked in electrolyte, to ensure the presence of salt within the electrode, however an alternative method would be to include the salt in the formulation at the extrusion stage.

This laminate was punched into 12.8 mm disks and assembled into a Swagelok testing cell with glass fibre separator and lithium metal anode. 100 μL of additional electrolyte was added to enable the passage of lithium ions between anode and cathode.

Testing this half-cell enabled measurement of the available capacity of the cell, which indicated values slightly in excess of 170 mAh/g of active material.

In addition, rate testing was conducted on this half-cell at 30° C., and indicated >80% capacity was available at 1C (see FIG. 2).

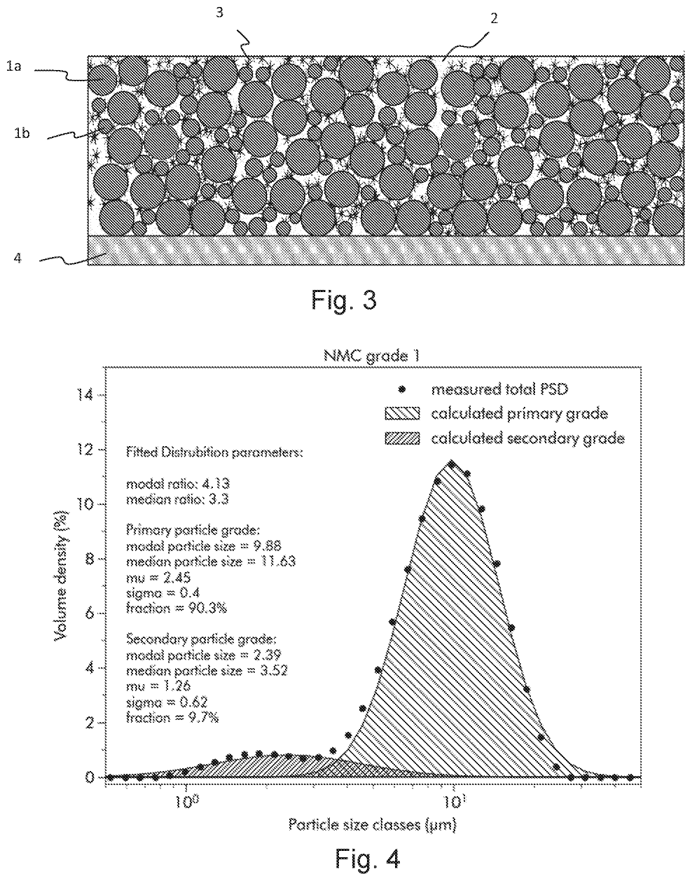

A schematic of an electrode according to the invention is illustrated in FIG. 3, in which there is a bimodal particle size distribution of the electro-active material (1a, 1b), disposed in a conductive polymer gel matrix (2), which also contains a conductive additive (3).

The electrode may be extruded onto a current collector (4). This is also illustrated in FIG. 3.

1. An electrode precursor composition for an alkali metal ion secondary cell comprising:
a polymer-solvent gel matrix phase; and
a dispersed phase comprising an electrochemically active material;
wherein the electrochemically active material has a multimodal particle size distribution having a D¹₅₀/D²₅₀ in the range 2 to 15;
wherein D¹₅₀ is a volumetric median particle size of a first particle mode within the distribution and D²₅₀ is a volumetric median particle size of a second particle mode within the distribution.

2. The electrode precursor composition according to claim 1, wherein a ratio of a volume fraction of the first particle mode to a volume fraction of the second particle mode is from 0.6 to 15.

3. The electrode precursor composition according to claim 2, wherein the ratio of the volume fraction of the first particle mode to the volume fraction of the second particle mode is from 2 to 4.

4. The electrode precursor composition according to claim 1, wherein the electrochemically active material has a multimodal particle size distribution having a D¹₅₀/D²₅₀ in the range 6 to 8.

5. The electrode precursor composition according to claim 1, wherein the electrochemically active material makes up at least 60 vol % of the electrode precursor composition.

6. The electrode precursor composition according to claim 1, wherein the dispersed phase further comprises a conductive additive.

7. The electrode precursor composition according to claim 6, wherein the conductive additive comprises one or more selected from the group consisting of carbon black and graphite.

8. The electrode precursor composition according to claim 6, wherein the conductive additive is present in an amount of from 1.5 wt % to 2.5 wt %, based on a total weight of electrode precursor composition.

9. The electrode precursor composition according to claim 1, wherein the polymer-solvent gel matrix phase comprises a mixture of a gelling polymer and a liquid electrolyte, wherein a weight ratio of liquid electrolyte:gelling polymer is from 2 to 6.

10. The electrode precursor composition according to claim 9, wherein the polymer-solvent gel matrix phase comprises the gelling polymer in an amount of from 15 to 25 vol %, based on a total volume of polymer-solvent gel matrix phase.

11. The electrode precursor composition according to claim 9, wherein the liquid electrolyte comprises a solvent comprising one or more cyclic or linear carbonate compounds.

12. The electrode precursor composition according to claim 1, wherein the polymer-solvent gel matrix phase makes up from 20 vol % to 50 vol % of the electrode precursor composition.

13. The electrode precursor composition according to claim 1, wherein the electrochemically active material is a positive active material.

14. The electrode precursor composition according to claim 1, wherein the electrochemically active material is a lithium transition metal oxide material.

15. The electrode precursor composition according to claim 1, wherein the electrochemically active material has a bimodal particle size distribution.

16. The electrode precursor composition according to claim 1, wherein the polymer-solvent gel matrix phase comprise one or more gelling polymers selected from the group consisting of poly(ethyleneglycol dimethacrylate), poly(ethyleneglycol diacrylate), poly(propyleneglycol dimethacrylate), poly(propyleneglycol diacrylate), poly(methyl methacrylate) (PMMA), poly(acrylonitrile) (PAN), polyurethane (PU), poly(vinylidene difluoride) (PVdF), poly(vinylidene fluoride-co-hexafluoropropylene) (PvDF-HFP), poly(ethylene oxide) (PEO), poly(ethyleneglycol dimethylether), poly(ethyleneglycol diethylether), poly[bis(methoxy ethoxyethoxide)-phosphazene], poly(dimethylsiloxane) (PDMS), polyacene, polydisulfide, polystyrene, polystyrene sulfonate, polypyrrole, polyaniline, polythiophene, polythione, polyvinyl pyridine (PVP), polyvinyl chloride (PVC), polyaniline, poly(3,4-ethylenedioxythiophene) (PEDOT), poly(p-phenylene), poly(triphenylene), polyazulene, polyfluorene, polynaphthalene, polyanthracene, polyfuran, polycarbazole, tetrathiafulvalene-substituted polystyrene, ferrocene-substituted polyethylene, carbazole-substituted polyethylene, polyoxyphenazine, poly(heteroacene), poly[(4-styrenesulfonyl) (trifluoromethanesulfonyl)imide-co-methoxy-polyethyleneglycolacrylate] (Li[PSTFSI-co-MPEGA]), sulfonated poly(phenylene oxide) (PPO), N,N-dimethylacryl amide (DMAAm), lithium 2-acrylamido-2-methyl-1-propane sulfonate (LiAMPS), Poly(lithium 2-Acrylamido-2-Methylpropanesulfonic Acid-Co-Vinyl Triethoxysilane), polyethyleneoxide (PEO)/poly(lithium sorbate), PEO/poly(lithium muconate), PEO/[poly(lithium sorbate)+BF₃], PEO copolymer, PEO terpolymer, and NIPPON SHOKUBAI® polymer.

17. (canceled)

18. An electrode for an alkali metal ion secondary cell comprising:
a polymer-solvent gel matrix phase; and
a dispersed phase comprising an electrochemically active material;
wherein the electrochemically active material has a multimodal particle size distribution having a D¹₅₀/D²₅₀ in range 2 to 15;
wherein D¹₅₀ is a volumetric median particle size of a first particle mode within the distribution and D²₅₀ is a volumetric median particle size of a second particle mode within the distribution.

19-22. (canceled)

23. A method of preparing an electrode for an alkali metal ion secondary cell, comprising:
mixing a polymer, an electrolyte and an electrochemically active material to form an electrode precursor composition according to claim 1; and
thermally processing the electrode precursor composition to form an electrode film.

24. The method according to claim 23, wherein the electrode film has a thickness of from 500 to 700 μm.

25. The method according to claim 23, further comprising cutting the electrode film to form an electrode of predetermined dimensions.

26-27. (canceled)
